(19) United States
(12) Patent Application Publication
(10) Pub. No.: US 2014/0351729 A1
(43) Pub. Date: Nov. 27, 2014

(54) METHOD OF OPERATING APPLICATION AND ELECTRONIC DEVICE IMPLEMENTING THE SAME

(71) Applicant: Samsung Electronics Co., Ltd., Suwon-si (KR)

(72) Inventor: Youngjoo PARK, Yongin-si (KR)

(73) Assignee: Samsung Electronics Co., Ltd., Suwon-si (KR)

(21) Appl. No.: 14/283,986

(22) Filed: May 21, 2014

Related U.S. Application Data
(60) Provisional application No. 61/825,725, filed on May 21, 2013.

(30) Foreign Application Priority Data
Oct. 18, 2013 (KR) 10-2013-0124868

(51) Int. Cl. G06F 3/0481; G06F 3/0488; G06F 3/0484

(52) U.S. Cl. CPC G06F 3/0481; G06F 3/04842; G06F 3/0488
USPC 715/767

(57) ABSTRACT

An electronic device capable of multitasking is provided. A method of operating an electronic device includes displaying a window of a foreground application, displaying at least one window of background applications on at least a part of the window of the foreground application, detecting a user input for selecting one of the at least one window of the background applications, and assigning a foreground authority to a background application corresponding to the selected one window to update the selected one window.

### CROSS-REFERENCE TO RELATED APPLICATION(S)

This application claims the benefit under 35 U.S.C. §119(e) of a U.S. Provisional application filed on May 21, 2013 in the U.S. Patent and Trademark Office and assigned Ser. No. 61/825,725, and under 35 U.S.C. §119(a) of a Korean patent application filed on Oct. 18, 2013 in the Korean Intellectual Property Office and assigned Serial number 10-2013-0124868, the entire disclosure of each of which is hereby incorporated by reference.

### TECHNICAL FIELD

The present disclosure relates to an electronic device capable of multitasking.

### BACKGROUND

Currently, electronic devices such as a smart phone, a tablet Personal Computer (PC) and the like, support multitasking that allows a user to simultaneously perform multiple tasks. For example, the user may read an article or play a game by using the electronic device. When a short message is received by the electronic device, the electronic device may inform the user that the short message has been received. The electronic device may display a window of a message application in response to a request of the user and transmit a reply message input through the window. The electronic device may display the previous application window (that is, the article or the game related window) again in response to a request of the user after completely sending the message. At this time, when another short message is received, the user does not need to load the message application again to reply to the short message. As described above, the user is required to switch applications in order to perform a desired task. However, such a switching operation may cause the user to feel inconvenience.

Accordingly, an apparatus and a method for temporarily displaying a window of a background application on a part of a window of a foreground application to perform a task of the background application are desired.

Other aspects, advantages, and salient features of the disclosure will become apparent to those skilled in the art from the following detailed description, which, taken in conjunction with the annexed drawings, discloses various embodiments of the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for temporarily displaying a window of a background application on a part of a window of a foreground application to perform a task of the background application.

The background and foreground applications may be applications in an execution mode. The execution mode may be a state where the corresponding application is loaded to a main memory from a secondary memory and being executed by an operating system. The foreground application may be an application having an access authority of a screen. In other words, the foreground application may be an application performing a task having a highest priority.

In accordance with an aspect of the present disclosure, a method of operating an electronic device is provided. The method includes displaying a window of a foreground application, displaying at least one window of background applications on at least a part of the window of the foreground application, detecting a user input for selecting one of the at least one window of the background applications, and assigning a foreground authority to a background application corresponding to the selected one window to update the selected one window.

In accordance with another aspect of the present disclosure, an electronic device is provided. The electronic device includes a display unit configured to display a window of an application, an input unit configured to detect a user input, a task manager configured to perform an operation to display a window of a foreground application, an operation to display at least one window of background applications on a part of the window of the foreground application, an operation to detect a user input for selecting one of the at least one window of the background applications, and an operation to assign a foreground authority to a background application corresponding to the selected one window to update the selected one window, and at least one processor for executing the task manager.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device according to an embodiment of the present disclosure;

FIG. 2 is a flowchart describing an example of a process of temporarily assigning a foreground authority to a background application to perform a task according to an embodiment of the present disclosure;

FIG. 3 is a flowchart describing another example of the process of temporarily assigning the foreground authority to the background application to perform the task according to an embodiment of the present disclosure;

FIG. 4 is a flowchart describing an example of a process of changing a foreground application according to an embodiment of the present disclosure;

FIGS. 5A, 5B, 5C, and 5D illustrate screens for describing an example of an interaction process with a message application according to an embodiment of the present disclosure;

FIGS. 6A and 6B illustrate screens for describing an example of an interaction process with a plurality of applications according to an embodiment of the present disclosure; and

FIG. 7 is a flowchart describing an example of a process of updating a background application window temporarily assigned a foreground authority according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device according to the present disclosure may be a computing device, such as a smart phone, a camera, a tablet Personal Computer (PC), a notebook PC, a desktop PC, a media player (for example, MP3 player), a Personal Digital Assistance (PDA), a terminal for a game, a wearable computer (for example, watch or glasses) or the like. Further, the electronic device according to the present disclosure may be a home appliance (for example, refrigerator, TV, washing machine or the like) equipped with the computing device therein, but the electronic device is not limited thereto.

The electronic device according to the present disclosure may display “a background interface including at least one background application window” on a part of a foreground application window in response to a request of a user (for example, tapping a message reception notification displayed on a screen). The electronic device may temporarily (short session) assign a foreground authority to a background application of the window selected from the background interface. That is, the electronic device may update the selected background application window and display the updated background application window. The electronic device may stop displaying the background interface in response to a user's request (for example, tapping the foreground application window). That is, the electronic device may assign the foreground authority to the original application again. As described above, the electronic device may temporarily assign the foreground authority to the background application to provide an interaction which allows the user to perform a task of the background application.

Hereinafter various embodiments of the present disclosure will be described in detail with reference to the accompanying drawings. In describing the various embodiments, descriptions of technologies which are already known to those skilled in the art and are not directly related to the present disclosure may be omitted. Further, detailed descriptions of components having substantially the same configuration and function may be omitted. In the drawings, some components may be exaggerated, omitted, or schematically illustrated.

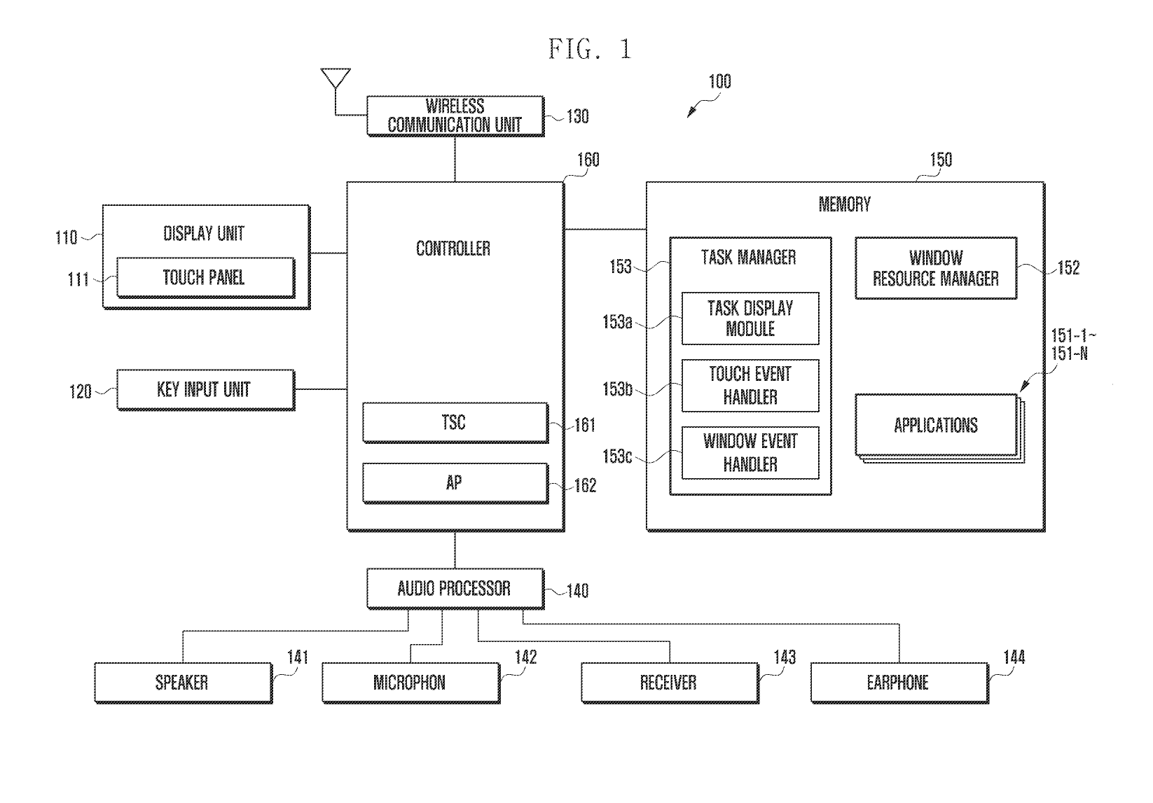

FIG. 1 is a block diagram of an electronic device according to an embodiment of the present disclosure.

Referring to FIG. 1, an electronic device 100 may include a display unit 110, a key input unit 120, a wireless communication unit 130, an audio processor 140, a speaker 141, a microphone 142, a receiver 143, an earphone 144, a memory 150, and a controller 160.

The display unit 110 may display various pieces of information on a screen under a control of the controller, particularly, an Application Processor (AP). For example, the controller 160 processes (for example, decodes) information and stores the processed information in a memory 150 (for example, a frame buffer). For example, a plurality of application windows may be stored in the frame buffer. The display unit 110 may convert data stored in the frame buffer to an analog signal and display the analog signal on the screen. For example, the display unit 110 may display a foreground application window among the plurality of application windows. Further, the display unit 110 may display a background interface on a part of the foreground application window. A background application window selected from the background interface by the user may be updated and then stored in the frame buffer. Then, the display unit 110 may display the updated background application window on a part of the foreground application window.

The display unit 110 may be implemented by a Liquid Crystal Display (LCD), an Active Matrix Organic Light Emitted Diode (AMOLED), a flexible display, or a transparent display.

When power is supplied to the display unit 110, the display unit 110 may display a lock image on the screen. When a user input (for example, password) for releasing the lock is detected in a state where the lock image is displayed, the controller 160 may release the lock. When the lock is released, the display unit 110 may display, for example, a home image instead of the lock image on the screen under a control of the controller 160. The home image may include a background and icons displayed on the background. The icons may indicate applications, contents (for example, picture file, video file, recording file, document, message and the like) or the like. When a user input for executing an application icon is detected, the controller 160 may execute the corresponding application and control the display unit 110 to display the window on the screen. Meanwhile, the screen may be referred to as a name related to a target to be displayed. For example, the screen displaying the lock image, the screen displaying the home image, and the screen displaying an execution image (that is, window) of the application may be referred to as a lock screen, a home screen, and an execution screen, respectively.

A touch panel 111 is installed in the screen of the display unit 110. That is, the display unit 110 may include the touch panel 111 as an input unit. For example, the touch panel 111 may be implemented in an add-on type located on the screen of the display unit 110, or an on-cell type or an in-cell type inserted into the display unit 110.

The touch panel 111 may include a hand touch panel in a capacitive type. The hand touch panel may include a plurality of scan input ports (hereinafter referred to as scan ports) and a plurality of detection output ports (hereinafter referred to as detection ports). The hand touch panel may generate detection information (for example, an amount of a change in capacitance) in response to a touch of a conductive object (for example, finger) by a scan control signal of a touch screen controller of the controller 160 input into the scan port and transmit the generated detection information to the touch screen controller through the detection port.

The touch panel 111 may include a pen touch panel called a digitizer sensor substrate. The pen touch panel may be implemented in an Electro-Magnetic Resonance (EMR) type. Accordingly, the pen touch panel may generate detection information in response to a hovering and/or touch of a pen manufactured specially for formation of a magnetic field and transmit the generated detection information to the touch screen controller of the controller 160. The pen may include a button. For example, when the user presses the button, a magnetic field generated in a coil of the pen may be changed. The pen touch panel may generate detection information in response to the change in the magnetic field and transmit the generated detection information to the touch screen controller of the controller 160.

The key input unit 120 may include at least one touch key in a capacitive type. The touch key may generate a key event in response to a touch of the conductive object and transmit the generated key event to the controller 160. The key input unit 120 may further include a key in a different type from the touch type. For example, the key input unit 120 may include at least one dome key. When the user presses the dome key, the dome key is transformed to contact a printed circuit board, and accordingly, a key event is generated on the printed circuit board and transmitted to the controller 160. Meanwhile, the key of the key input unit 120 may be called a hard key and the key displayed on the display unit 110 may be called a soft key.

The wireless communication unit 130 may perform a voice call, a video call, or data communication with an external device through a network under a control of the controller 160. The wireless communication unit 130 may include a mobile communication module (for example, 3-generation mobile communication module, 3.5-generation mobile communication module, 4-generation mobile communication module or the like), a digital broadcasting module (for example, Digital Multimedia Broadcasting (DMB) module), and a short distance communication module (for example, Wi-Fi module, Bluetooth module, Near Field Communication (NFC) module).

The audio processor 140 may be combined with the speaker 141, the microphone 142, the receiver 143, and the earphone 144 to input and output an audio signal (for example, voice data) for a voice recognition, a voice recording, a voice modulation, a digital recording, and a call. The audio processor 140 receives an audio signal (for example, voice data) from the controller 160, D/A-converts the received audio signal to an analog signal, amplifies the analog signal, and then outputs the analog signal to the speaker 141, the receiver 143, or the earphone 144. The earphone 144 can be connected to and disconnected from the electronic device 100 through an ear jack. When the earphone 144 is connected to the audio processor 140, the audio processor 140 may output an audio signal to the earphone 144. When a call mode is a speaker mode, the audio processor 140 may output an audio signal to the speaker 141. When a call mode is a receiver mode, the audio processor 140 may output an audio signal to the receiver 143. The speaker 141, the receiver 143, and the earphone 144 convert an audio signal received from the audio processor 140 to a sound wave and output the sound wave. The microphone 142 converts a sound wave transmitted from a human or another sound source to an audio signal. Meanwhile, the earphone 144 may be a four pole earphone, that is, an earphone having a microphone. The audio processor 140 A/D-converts an audio signal received from the microphone 142 or the microphone of the earphone 144 to a digital signal and then transmits the digital signal to the controller 160.

The audio processor 140 may provide an auditory feedback (for example, voice or sound) related to a display of the background application window to the user under a control of the controller 160. For example, when at least one background application window is displayed on a part of the foreground application window, the audio processor 140 may reproduce voice data or sound data that guides the display. When the displaying of the background application window is stopped, the audio processor 140 may reproduce voice data or sound data that guides the stopping of the display. When one of the displayed background application windows is set as the foreground application window, the audio processor 140 may reproduce voice data or sound data that guides the setting.

The memory 150 may store data generated according to an operation of the electronic device 100 and/or received from an external device through the wireless communication unit 130 under a control of the controller 160. The memory 150 may include a buffer as temporary data storage. The memory 150 may store various pieces of setting information (for example, screen brightness, whether to generate a vibration when a touch is generated, whether to automatically rotate a screen) for setting a use environment of the electronic device 100. Accordingly, the controller 160 may operate the electronic device with reference to the setting information.

The memory 150 may store a window resource manager 152 managing various programs for operating the electronic device 100, for example, a booting program, one or more operating systems, applications 151_1 to 151_N, and resources of application windows. For example, when an operating system is Linux, the window resource manager 152 may be an X server. Particularly, the memory 150 may store a task manager 153.

The task manager 153 may be configured to perform an operation for displaying “a background interface including at least one background application (hereinafter referred to as app) window” on a part of a foreground app window in response to a request for displaying the background app window, an operation for making a request for updating the corresponding window to an app of the window selected from the background interface, and an operation for displaying the window updated by the corresponding app. That is, the task manager 153 may temporarily (short session) assign a foreground authority to the app of the selected window.

The task manager 153 may be configured to perform an operation for changing the foreground app in response to a replacement request while the background interface is displayed and an operation for displaying another background app window in response to a movement request while the background interface is displayed.

The task manager 153 may include a touch event handler 153b, a window event handler 153c, and a task display module 153a. The touch event handler 153b may be configured to perform an operation for transmitting a touch event to the window resource manager 152. The window event handler 153c may be configured to perform an operation for acquiring information on the updated background app window and controlling the task display module 153a to display the acquired information. The task display module 153a may be configured to perform an operation for displaying the updated background app window.

The memory 150 may include a main memory and a secondary memory. The main memory may be implemented by, for example, a Random Access Memory (RAM) or the like. The secondary memory may be implemented by a disc, a RAM, a Read Only Memory (ROM), a flash memory, or the like. The main memory may store various programs loaded from the secondary memory, for example, a booting program, an operating system, and applications. When power of a battery is supplied to the controller 160, the booting program may be first loaded to the main memory. The booting program may load the operating system to the main memory. The operating system may load the app to the main memory. The controller 160 (for example, AP) may access the main memory to decode a command (routine) of the program and execute a function according to a decoding result. That is, the various programs may be loaded to the main memory and run as processes.

The controller 160 controls general operations of the electronic device 100 and a signal flow between internal components of the electronic device 100, performs a function of processing data, and controls power supply to the components from the battery. The controller 160 may include a touch screen controller 161 and an AP 162.

The touch screen controller 161 may receive detection information from the touch screen panel 111, analyze the received detection information, and recognize generation of a touch, a hovering, or pressing of a pen. The touch screen controller 161 may determine a hovering area on the touch screen in response to the hovering and calculate hovering coordinates (x_hovering and y_hovering) in the hovering area. The touch screen controller 161 may transmit a hovering event including the calculated hovering coordinates to the AP 162. Further, the hovering event may include a depth value. For example, the hovering event may include a three dimensional coordinate (x, y, and z). Here, a z value may refer to a depth. The touch screen controller 161 may determine a touch area on the touch screen in response to the touch and calculate touch coordinates (x_touch and y_touch) in the touch area. The touch screen controller 161 may transmit a touch event including the calculated touch coordinates to the AP 162. The touch screen controller 161 may transmit a pen button event to the AP 162 in response to pressing of the pen button.

The AP 162 may receive a touch screen event (for example, hovering event, touch event, pen button event or the like) from the touch screen controller 161 and perform a function corresponding to the touch screen event.

When the hovering coordinate is received from the touch screen controller 161, the AP 162 may determine that a pointing device hovers on the touch screen. When the hovering coordinate is not received from the touch panel 111, the AP 162 may determine that the hovering of the pointing device is released from the touch screen. Further, when a hovering coordinate is changed and a change amount of the hovering coordinate exceeds a preset movement threshold, the AP 162 may determine that a hovering movement of the pointing device is generated. The AP 162 may calculate a position change amount (dx and dy) of the pointing device, a movement speed of the pointing device, and a trace of the hovering movement in response to the hovering movement of the pointing device. Further, the AP 162 may determine a hovering gesture for the touch screen based on the hovering coordinate, whether the hovering of the pointing device is released, whether the pointing device moves, the position change amount of the pointing device, the movement speed of the pointing device, and the trace of the hovering movement. The hovering gesture may include, for example, a drag, a flick, a pinch in, and a pinch out.

When the touch coordinate is received from the touch screen controller 161, the AP 162 may determine that the pointing device touches the touch panel 111. When the touch coordinate is not received from the touch panel 111, the AP 162 may determine that the touch of the pointing device is released from the touch screen. Further, when a touch coordinate is changed and a change amount of the touch coordinate exceeds a preset movement threshold, the AP 162 may determine that a touch movement of the pointing device is generated. The AP 162 may calculate a position change amount (dx and dy) of the pointing device, a movement speed of the pointing device, and a trace of the touch movement in response to the touch movement of the pointing device. Further, the AP 162 may determine a touch gesture for the touch screen based on the touch coordinate, whether the touch of the pointing device is released, whether the pointing device moves, the position change amount of the pointing device, the movement speed of the pointing device, and the trace of the touch movement. The touch gesture may include a touch, a multi-touch, a tap, a double tap, a long tap, a drag, a flick, a press, a pinch in, and a pinch out.

The AP 162 may receive a key event from the key input unit 120 and perform a function corresponding to the key event.

The AP 162 may execute various types of programs stored in the memory 150. That is, the AP 152 may load various types of programs to the main memory from the secondary memory and executes the programs as processes. Particularly, the AP 162 may execute the task manager 153 as a process.

Meanwhile, the controller 160 may further include various processors as well as the AP 162. For example, the controller 160 may include a Graphic Processing Unit (GPU) that takes charge of graphic processing. Further, when the electronic device 100 includes a mobile communication module (for example, 3-generation mobile communication module, 3.5-generation mobile communication module, 4-generation mobile communication module or the like), the controller 160 may further include a Communication Processor (CP) that takes charge of mobile communication processing. The aforementioned processors may be integrated into one package in which two or more independent cores (for example, quad-core) are implemented by a single integrated circuit. For example, the AP 162 may be integrated into one multi-core processor. The aforementioned processors may be a System on Chip (SoC). Further, the aforementioned processors may be packaged as a multi-layer.

Meanwhile, the electronic device 100 may further include components which have not been mentioned above, such as a Global Positioning System (GPS) reception module, a vibration motor, a camera, an acceleration sensor, a gyro sensor, a proximity sensor and the like. When the electronic device 100 is set to be in an automatic rotation mode, the controller 160 may analyze detection information collected from sensors to calculate a posture of the electronic device 100 and determine a display mode as one of a landscape mode and a portrait mode by using the calculated value.

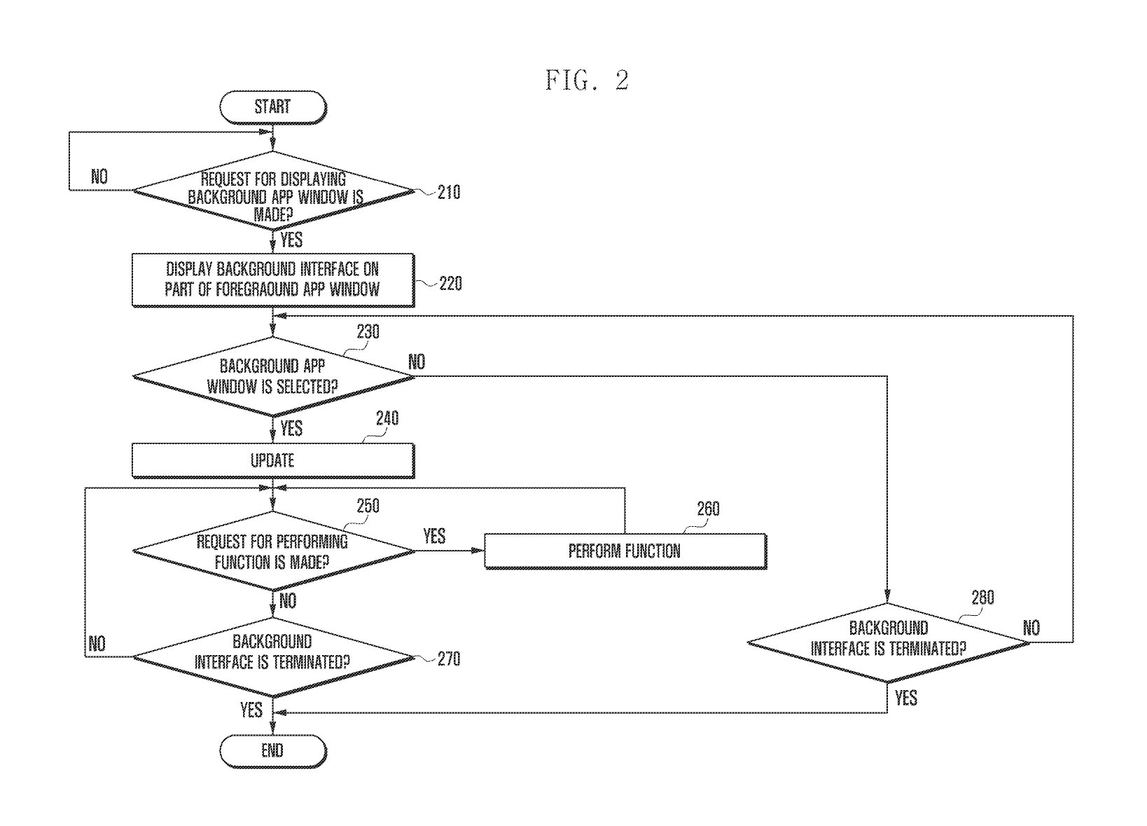

FIG. 2 is a flowchart describing an example of a process of temporarily assigning a foreground authority to a background app and to perform a task according to an embodiment of the present disclosure.

Referring to FIG. 2, in operation 210, the controller 160 identifies whether a user input for making a request for displaying a background app window is detected. The user input may be a particular touch gesture. When the touch gesture is detected, the controller 160 compares the detected touch gesture with a preset value and identifies whether the detected touch gesture is the user input for making a request for displaying the background app window. For example, a pinch-in may be set as the user input for displaying the background app window. Of course, another touch gesture or a particular hovering gesture may be set as the user input for displaying the background app window. Meanwhile, the user input for making a request for displaying the background app window may be an input for selecting (for example, tapping a particular icon by the user) a particular icon displayed on the screen. Further, the user input may be a key event. In addition, the user input may be a voice command event input through the microphone 142 or the microphone of the earphone 144.

When the user input for making a request for displaying the background app window is detected in operation 210, the controller 160 controls the display unit 110 to display a background interface on a part of the foreground app window in operation 220. Otherwise, the controller 160 continues to determine if user input for making a request for displaying the background app window is detected at operation 210. The background interface may include at least one of the background app windows stored in the memory (for example, frame buffer). The foreground app window is a window displayed on a screen before the user input is detected. That is, the foreground app window is a window of the app having an access authority of the screen. For example, the foreground app window may be a lock image, a home image, a game image, a webpage, a document or the like. Further, the screen may display a plurality of foreground app windows. For example, when a foreground authority is assigned to a plurality of applications, the screen is divided into a plurality of areas and foreground app windows may be displayed on the respective divided areas. Meanwhile, when a user input for making a request for changing the background app window is detected, the controller 160 may control the display unit 110 to display another background app window in response to the user input. For example, when a flick or drag is generated in the background interface, the window of application A disappears and the window of application B may be displayed.

In operation 230, the controller 160 identifies whether a user input for selecting the background app window from the background interface is detected. The user input may be a tap on the corresponding window. Further, the user input may be a voice command event input through the microphone 142 or the microphone of the earphone 144.

When the user input for selecting the background app window is detected in operation 230, the controller 160 temporarily assigns a foreground authority to the app of the selected window. That is, in operation 240 the controller 160 updates the selected window. For example, when a messenger window is selected, the controller 160 identifies whether new information (for example, message, notice, or update) related to the messenger has been received. As a result of the identification, when there is the new information, the controller 160 may control the display unit 110 to display the new information on the corresponding window.

In operation 250, the controller 160 identifies whether a user input for making a request for performing a function is detected. When the user input for making a request for performing the function is detected in operation 250, the controller 160 performs the corresponding requested function in operation 260. For example, when an input window is selected in the background app window, the controller 160 may control the display unit 110 to display a keypad on a part of the corresponding window. A message input through the keypad may be displayed on the input window. When transmission of the message is selected (for example, tap on a send button), the controller 160 may control the wireless communication unit 130 to transmit the message displayed on the input window to a device of a chatting counterpart. After operation 260, the process may return to operation 250. When the user input for making a request for performing the function is not detected in operation 250, the process may proceed to operation 270.

In operation 270, the controller 160 identifies whether a user input for making a request for terminating the background interface is detected. For example, when the user taps the foreground app window, displaying of the background interface is terminated and the process may end. Alternatively, the process may return to operation 210. When the user input for making a request for terminating the background interface is not detected in operation 280, the process may return to operation 250.

When the user input for selecting the background app window is not detected in operation 230, the process may return to operation 280. In operation 280, the controller 160 identifies whether the user input for making a request for terminating the background interface is detected. When the user input for making a request for terminating the background interface is detected, displaying of the background interface is terminated and the process may end. Alternatively, the process may return to operation 210. Further, the controller 160 assigns the foreground authority to the foreground app again. When the user input for making a request for terminating the background interface is not detected, the process may return to operation 230.

Meanwhile, when there is no user input during a preset time (for example, one minute) from a time point of the displaying, the background interface may be automatically terminated. Accordingly, the process may return to operation 210.

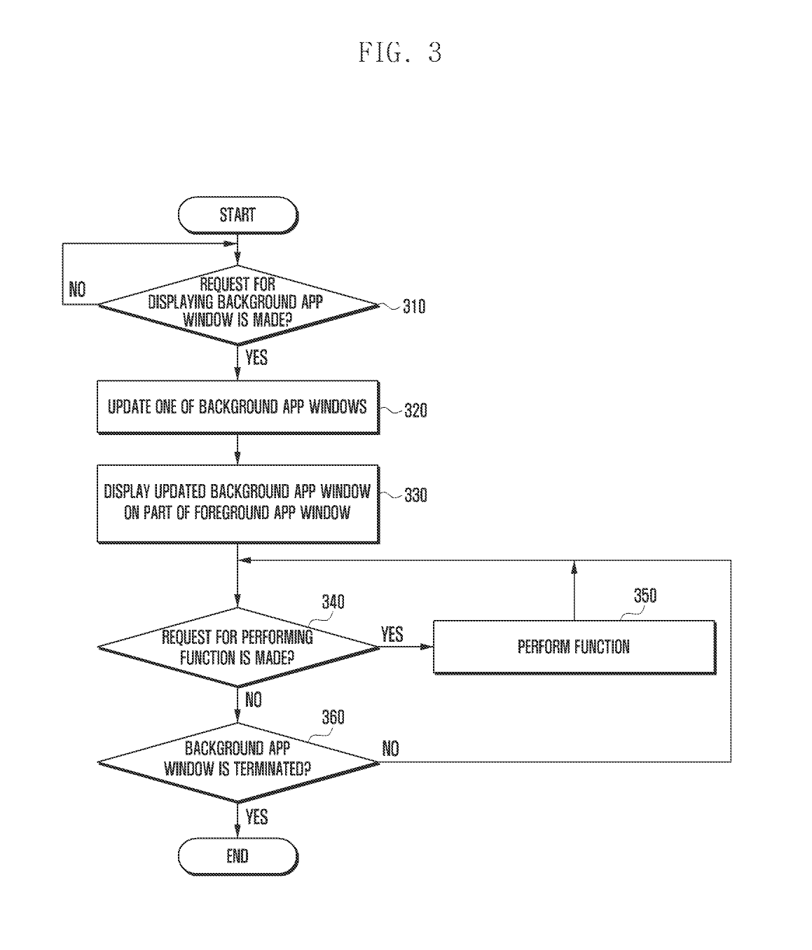

FIG. 3 is a flowchart describing another example of the process of temporarily assigning the foreground authority to the background app to perform the task according to an embodiment of the present disclosure.

Referring to FIG. 3, in operation 310, the controller 160 identifies whether a user input for making a request for displaying a background app window is detected. For example, an indicator related to the background app may be displayed on the screen together with the foreground app window. For example, when a message, update information, a notice or the like is received from the outside through the wireless communication unit 130, an indicator indicating the corresponding background appl may be displayed on the screen. The user input may be a tap on the indicator.

When the user input for making a request for displaying the background app window is detected in operation 310, the controller 160 updates one of the background app windows in operation 320. The window to be updated may be a window of the background app corresponding to the indicator selected by the user. Otherwise, the controller 160 continues to determine if the user input for making a request for displaying the background app window occurs at operation 310.

In operation 330, the controller 160 may control the display unit 110 to display the updated background app window on a part of the foreground app window.

In operation 340, the controller 160 identifies whether a user input for making a request for performing a function is detected. When the user input for making a request for performing the function is detected in operation 340, the controller 160 performs the corresponding requested function in operation 350. After operation 350, the process may return to operation 340. When the user input for making a request for performing the function is not detected in operation 340, the process may proceed to operation 360.

In operation 360, the controller 160 identifies whether a user input for making a request for terminating the background app window is detected. For example, when the user taps the foreground app window, displaying of the background interface is terminated and the process may end. Alternatively, the process may return to operation 310. Further, the controller 160 assigns the foreground authority to the foreground app again. When the user input for making a request for terminating the background app window is not detected in operation 360, the process may return to operation 340.

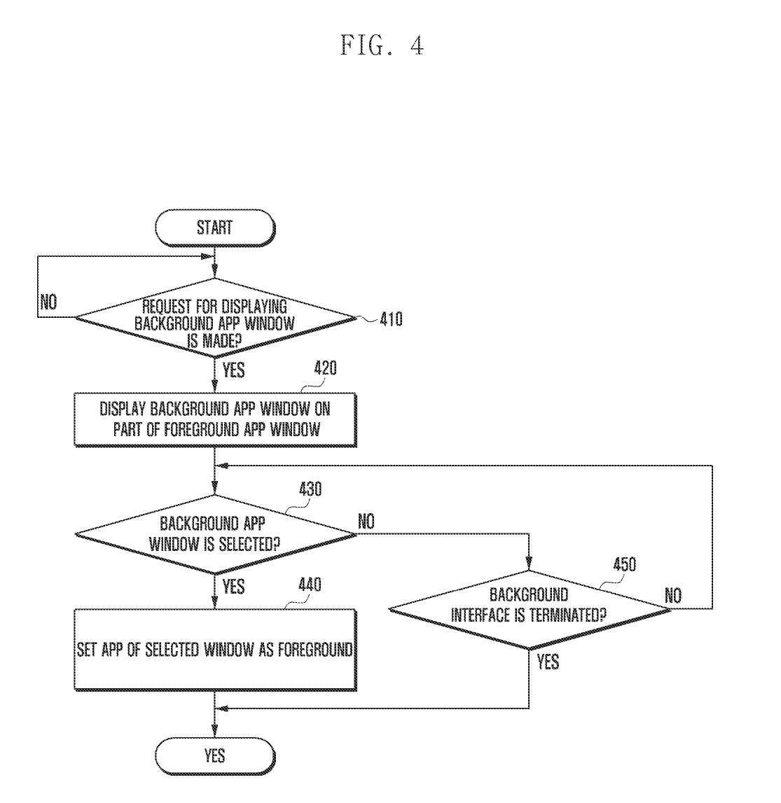

FIG. 4 is a flowchart describing an example of a process of changing the foreground app according to an embodiment of the present disclosure.

Referring to FIG. 4, in operation 410, the controller 160 identifies whether a user input for making a request for displaying a background app window is detected. When the user input for making a request for displaying the background app window is detected in operation 410, the controller 160 controls the display unit 110 to display a background interface on a part of the foreground app window in operation 420. Otherwise, the controller 160 continues to identify whether a user input for making a request for displaying a background app window at operation 410. Meanwhile, when a user input for making a request for changing the background app window is detected, the controller 160 may control the display unit 110 to display another background app window in response to the user input. For example, when a flick or drag is generated in the background interface, the window of application A disappears and the window of application B may be displayed. Further, the controller 160 may temporarily assign a foreground authority to one of the displayed background app windows in response to a user's request.

In operation 430, the controller 160 identifies whether a user input for selecting the background app window from the background interface is detected. The user input may be a double tap on the corresponding window. Further, the user input may be a voice command event input through the microphone 142 or the microphone of the earphone 144.

When the user input for selecting the background app window is detected in operation 430, the controller 160 newly sets the app of the selected window as the foreground app. Further, the controller 160 may terminate displaying of the background interface and control the display unit 110 to display the newly set foreground app window on the screen. When performance of operation 440 is completed, the process may end. Alternatively, the process may return to operation 410.

When the user input for selecting the background app window is not detected in operation 430, the process may return to operation 450.

In operation 450, the controller 160 identifies whether the user input for making a request for terminating the background interface is detected. When the user input for making a request for terminating the background interface is detected, displaying of the background interface is terminated and the process may end. Alternatively, the process may return to operation 410. When the user input for making a request for terminating the background interface is not detected, the process may return to operation 430.

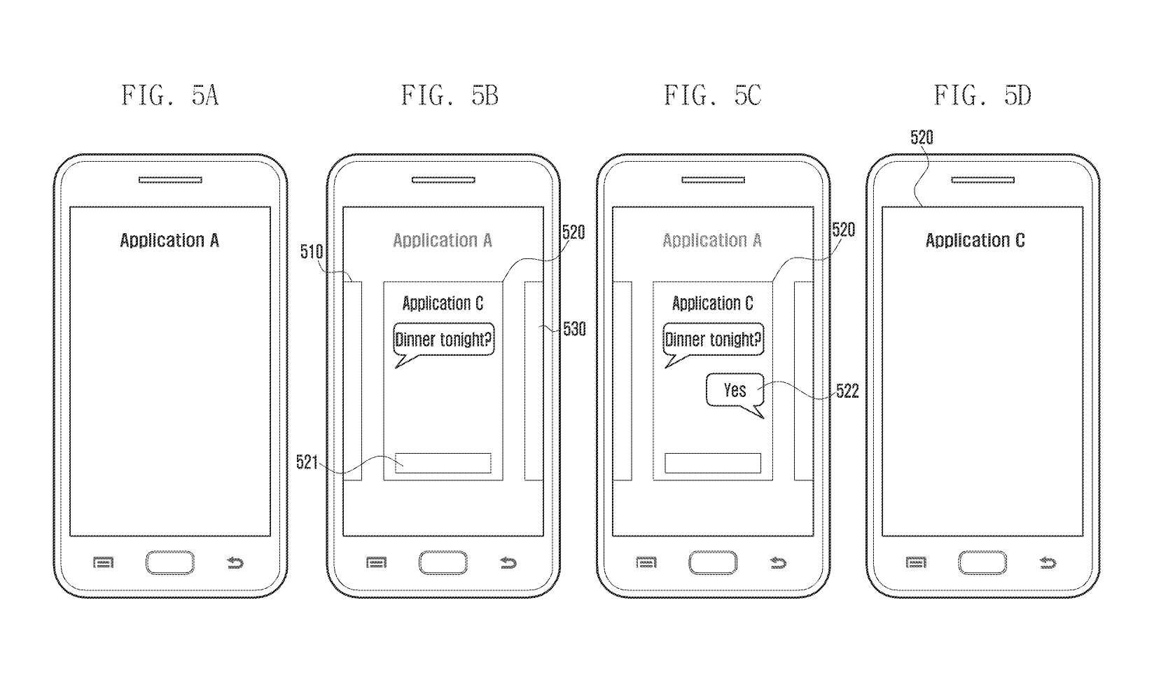

FIGS. 5A, 5B, 5C, and 5D illustrate screens for describing an example of an interaction process with a message app according to an embodiment of the present disclosure. A display mode may be a portrait mode.

Referring to FIG. 5A, a window of application A may be displayed on the screen as the foreground app window. Referring to FIG. 5B, when a user input for making a request for displaying the background app window is generated while application A is displayed, a window 520 of application C may be displayed on a part of the window of application A. Further, the window of application A may be blurredly displayed. In addition, only a part of a window 510 of application B and a part of a window 530 of application B may be displayed on left and right sides of the screen. Application C is a message app and the window 520 of application C may be selected (for example, tapped) by the user. Then, the controller 160 may temporarily assign the foreground authority to application C in response to the selection. When an input window 521 of application C is selected, the controller 160 may control the display unit 110 to display a keypad on a part of the corresponding window. A message input through the keypad may be displayed on the input window 521. When transmission of the message is selected, the controller 160 may control the wireless communication unit 130 to transmit the message displayed on the input window 521 to a device of a chatting counterpart. Referring to FIG. 5C, the controller 160 may control the display unit 110 to display a transmission message 522. Referring to FIG. 5D, the window 520 of application C may be selected (for example, double-tapped) by the user. Then, application C may be set as the foreground app. Accordingly, the window 520 of application C may be displayed on an entire screen as the foreground app window. Further, application A is set as the background app.

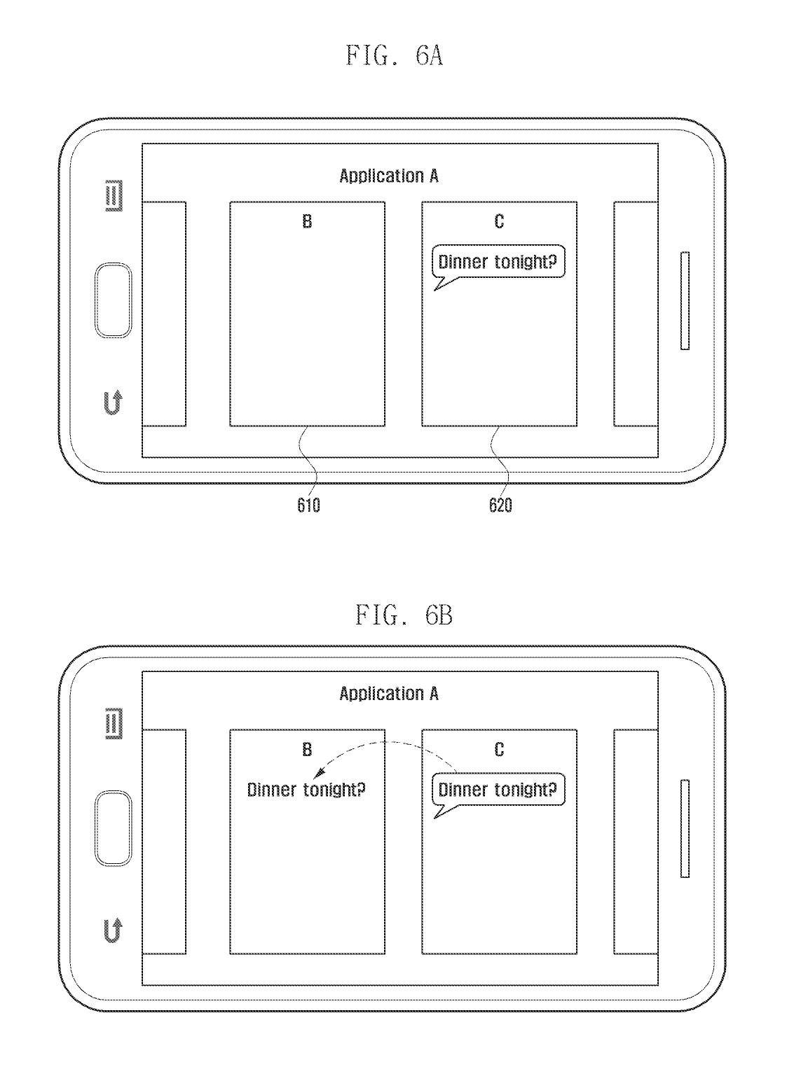

FIGS. 6A and 6B illustrate screens for describing an example of an interaction process with a plurality of applications according to an embodiment of the present disclosure. A display mode may be a landscape mode.

Referring to FIG. 6A, a window of application A may be displayed on the screen as the foreground app window. When a user input for making a request for displaying the background app window is generated while application A is displayed, a window 610 of application B and a window 620 of application C may be displayed on a part of the window of application A. The displayed background app windows 610 and 620 may be temporarily assigned the foreground authority. Referring to FIG. 6B, information exchange may be made between the background apps. For example, the user may touch a message 621 of the window 620 of application C by using a pointing device, move the pointing device to the window 610 of application B, and then release the touch. In response to such a drag & drop, the controller 160 may copy the message 620 and store the copied message in the memory (for example, clip board), and paste the message stored in the clip board to the window 610 of application B.

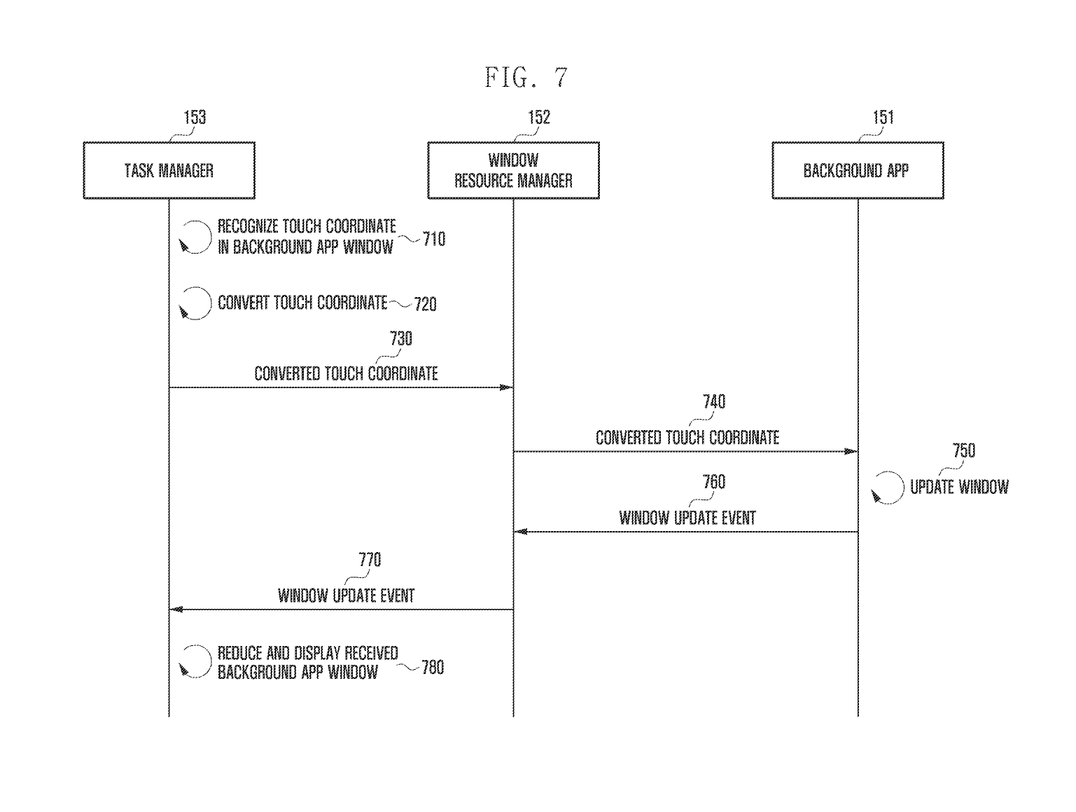

FIG. 7 illustrates a flow for describing an example of a process of updating a window of a background app temporarily assigned a foreground authority according to an embodiment of the present disclosure.

Referring to FIG. 7, in operation 710, the task manager 153 recognizes a touch coordinate in the background app window. The background app window may be displayed on a part of the foreground app window and may be displayed to be smaller than a preset size. Accordingly, in operation 720, the task manager 153 converts the touch coordinate with reference to a reduction rate of the background app window. That is, the recognized touch coordinate is converted to fit the preset size of the corresponding window. In operation 730, the task manager 153 transmits the converted touch coordinate to the window resource manager 152. Then, in operation 740, the window resource manager 152 transmits the converted touch coordinate to the corresponding background app 151. In operation 750, the background app 151 updates the window by using the converted touch coordinate. For example, when the converted touch coordinate corresponds to a request for displaying a keypad, the background app 151 includes the keypad into the window. In operation 760, the background app 151 transmits a window update event to the window resource manager 152. The window update event includes an updated window. Further, when an operating system is Linux, the window update event may be referred to as a damage event. In operation 770, the window resource manager 152 transmits the window update event to the task manager 153. In operation 780, the task manager 153 receives the updated window (that is, background app window) from the window resource manager 152, reduces the updated window with reference to the reduction rate, and displays the reduced window on the screen.

The method according to the present disclosure as described above may be implemented as a program command which can be executed through various computers and recorded in a computer-readable recording medium. The recording medium may include a program command, a data file, and a data structure. The program command may be specially designed and configured for the present disclosure or may be used after being known to those skilled in computer software fields. The recording medium may include magnetic media such as a hard disk, a floppy disk and a magnetic tape, optical media such as a Compact Disc Read-Only Memory (CD-ROM) and a Digital Versatile Disc (DVD), magneto-optical media such as a floptical disk, and hardware devices such as a ROM, a RAM and a flash memory. Further, the program command may include a machine language code generated by a compiler and a high-level language code executable by a computer through an interpreter and the like.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of operating an electronic device, the method comprising:
displaying a window of a foreground application;
displaying at least one window of background applications on a part of the window of the foreground application;
detecting a user input for selecting one of the at least one window of the background applications; and
assigning a foreground authority to a background application corresponding to the selected one window to update the selected one window.

2. The method of claim 1, further comprising:
terminating the displaying of the at least one window of the background application in response to a user input for making a request for terminating a window display and assigning the foreground authority to the foreground application again.

3. The method of claim 1, further comprising:
detecting a second user input for selecting one of the at least one window of the background applications; and
setting the background application corresponding to the window selected by the second user input as the foreground application.

4. The method of claim 1, further comprising:
displaying a window of another background application on the part of the window of the foreground application in response to a user input for making a request for a window change.

5. The method of claim 1, further comprising:
displaying information on a first background application window on a second background application window in response to a touch gesture of a pointing device on a touch screen.

6. The method of claim 5, further comprising:
simultaneously displaying the first background application window and the second background application window on the part of the window of the foreground application.

7. An electronic device comprising:
a display unit configured to display a window of an application;
an input unit configured to detect a user input;
a task manager configured to perform an operation to display a window of a foreground application, an operation for displaying at least one window of background applications on a part of the window of the foreground application, an operation to detect a user input for selecting one of the at least one window of the background applications, and an operation to assign a foreground authority to a background application corresponding to the selected one window to update the selected one window; and
at least one processor for executing the task manager.

8. The electronic device of claim 7, wherein the task manager is configured to perform an operation to terminate the displaying of the at least one window of the background applications in response to a user input for making a request for terminating a window display and assigning the foreground authority to the foreground application again.

9. The electronic device of claim 7, wherein the task manager is configured to perform an operation to detect a second user input for selecting one of the at least one window of the background applications and an operation for setting the background application corresponding to the window selected by the second user input as the foreground application.

10. The electronic device of claim 7, wherein the task manager is configured to perform an operation to display a window of another background application on the part of the window of the foreground application in response to a user input for making a request for a window change.

11. The electronic device of claim 7, wherein the input unit includes a touch panel installed in the display unit and the task manager is configured to perform an operation to display information on a first background application window on a second background application window in response to a touch gesture of a pointing device on a touch screen of the display unit.

12. The electronic device of claim 11, wherein the task manager is configured to perform an operation to simultaneously display the first background application window and the second background application window on the part of the window of the foreground application.

13. The electronic device of claim 7, wherein the task manager is configured to perform an operation to recognize a touch coordinate in the window of the background application displayed to be smaller than a preset size, an operation to convert the recognized touch coordinate to fit the preset size, an operation to transmit the converted touch coordinate to a corresponding background application, and an operation to receive an updated window from the background application and displaying the updated window.

14. The electronic device of claim 7, wherein the at least one processor include an application processor.

15. The electronic device of claim 7, wherein, when the foreground authority of the background application corresponding to the selected one window to update the selected one window has been assigned, a partial window of another application is displayed on at least one side of the selected one window.

16. A non-transitory computer-readable storage medium storing instructions that, when executed, cause at least one processor to perform the method of claim 1.
